(19) United States
(12) Patent Application Publication
(10) Pub. No.: US 2012/0182310 A1
(43) Pub. Date: Jul. 19, 2012

(54) DISPLAY DEVICE, DISPLAY METHOD AND RECORDING MEDIUM

(76) Inventor: Mikiya OKADA, Osaka (JP)

(21) Appl. No.: 13/349,676

(22) Filed: Jan. 13, 2012

(30) Foreign Application Priority Data
Jan. 17, 2011 (JP) 2011-007227

(51) Int. Cl. G09G 5/00

(52) U.S. Cl. 345/619

(57) ABSTRACT

A book data display device, including a display section for displaying content of an electronic book composed of images on a page basis, and a position receiving section for receiving a position specification on a display screen of the display section, for displaying the electronic book by page-turning display is configured to determine the speed and direction of the page-turning display, based on the mutual relationship between two points corresponding to position specifications received at the edge region of the image.

### CROSS-REFERENCE TO RELATED APPLICATION

This non-provisional application claims priority under 35 U.S.C. §119(a) on Patent Application No. 2011-7227 filed in Japan on Jan. 17, 2011, the entire contents of which are hereby incorporated by reference.

### BACKGROUND

1. Technical Field

The present invention relates to a display device, a display method and a recording medium storing a computer program, for sequentially displaying a group of images consisting of images on a page basis.

2. Description of Related Art

In recent years, a variety of mobile information terminal devices capable of playing digital content have been popular. Among them, particularly mobile information terminal devices which allow us to install so-called electronic books and enjoy reading anywhere, anytime are becoming widespread.

For example, Japanese Patent Application Publication No. 2008-176737 discloses an electronic book main body having a forward page turning switch and a backward page turning switch located with a sufficient space between them for preventing an erroneous operation even if the switch is manipulated with a part of body other than a finger, capable of turning pages with the use of a part of a body other than fingers (hands), and thus enabling even people having disabilities in hands or fingers to turn pages.

Japanese Patent Application Publication No. 2009-205565 discloses an information display terminal device which includes a flexible display section configured to be flexible for displaying information; a bent sensor for detecting a bending amount according to the bending of the display section; and an image display control section for controlling the scroll speed of information displayed in the display section, according to a detection result of the bent sensor, and implements the page-turning display of information at a scroll speed according to the bending amount of the display section.

Japanese Patent Application Publication No. 2004-185331 discloses a display device which includes a casing; a display panel arranged on the front surface of the casing; and elastically deformable flexible sections provided on both ends of the front surface of the casing, and allows a user to bend either of the flexible sections when he/she desires to update information displayed on the display panel, so that the information displayed on the display panel is updated according to the bending amount of the flexible section at this time.

Japanese Patent Application Publication No. 2006-53605 discloses an information display device which has a mode for displaying the thickness of pages and a mode for not displaying the thickness of pages in displaying information on a screen, and thereby allowing a user to gain information, such as the thickness of a book or the page position, like a book in the form of a paper medium and enabling more natural handling in understanding and learning the content of books.

Japanese Patent Application Publication No. 2000-163193 discloses an electronic book which includes: a finger input detection section for detecting the contact pressure, contact area and contact position of a finger brought into contact with a display section; a finger input determination section for determining a page turning input, a continuous page turning input, a bookmark insertion, a bookmark inserted location reference input, etc.; a page image update control section for controlling updating of a page image; a bookmark processing section for performing bookmark insertion and reference processes; and an image generation section for generating an image to be displayed in the display section, and realizes a human interface that is easy to use to input an operation, such as page turning.

### SUMMARY

However, the above-mentioned electronic book main body of Japanese Patent Application Publication No. 2008-176737, the information display terminal device of Japanese Patent Application Publication No. 2009-205565, and the display device of Japanese Patent Application Publication No. 2004-185331 have cost problems because they require special structures, such as page turning switches, a flexible display section configured to be flexible, or elastically deformable flexible sections on both ends of the casing, to achieve their objective effects.

Further, in either of Japanese Patent Application Publication No. 2008-176737 and Japanese Patent Application Publication No. 2000-163193, no effort is made to adjust the page turning speed and the page turning direction.

The present invention has been made with the aim of solving the above problems, and it is an object of the present invention to provide a display device, including a display section for displaying a group of images consisting of images on a page basis, and a position receiving section for receiving a position specification on a display screen of the display section, for a sequential display of the group of images based on position specifications received by the position receiving section, and a display method and a recording medium storing a computer program, which are capable of adjusting the page turning speed and page turning direction (display order) of so-called page-turning display (sequential display) by a simple operation, without requiring a special structure, by determining the speed and display order of the sequential display, based on the mutual relationship between two points corresponding to position specifications received at an edge region of the image, and thereby capable of giving users improved handling performance.

The display device according to the present invention is a display device, including a display section for displaying a group of images consisting of a plurality of images on a page basis, and a position receiving section for receiving a position specification on a display screen of the display section, for a sequential display of the group of images, based on position specifications received by the position receiving section, wherein the position receiving section receives position specifications of two points at an edge region of an image, and the display device comprises a display determination section for determining, based on a mutual relationship between the two points, a speed and display order of the sequential display.

According to the invention, when the position receiving section received position specifications of two points at an edge region of an image, the display device determines, based on a mutual relationship between the two points, a speed and display order of the sequential display of the group of images.

The display device according to the present invention is characterized in that the display determination section includes a speed determination section for determining a speed of the sequential display, based on a distance between the two points.

According to the invention, the display determination section includes the speed determination section, and the speed determination section evaluates the distance between the two points and determines, based on the distance, a speed of the sequential display of the group of images.

The display device according to the present invention is characterized in that when position specifications are received for a plurality of times after a first point corresponding to a previous position specification, the speed determination section regards a point corresponding to a position specification received last as a second point, and determines a speed of the sequential display based on a distance between the first point and the second point.

According to the invention, when position specifications are received for a plurality of times after the first point, for example, the speed determination section regards a point corresponding to the position specification received last as the second point, evaluates the distance between the first point and the second point, and determines, based on the distance, a speed of the sequential display of the group of images.

The display device according to the present invention is characterized in that the display determination section includes a speed determination section for determining, based on a time interval between the two points, a speed of the sequential display.

According to the invention, the display determination section includes the speed determination section, and the speed determination section determines a speed of the sequential display of the group of images, based on a time interval from reception of one of the position specifications of the two points to reception of the other position specification.

The display device according to the present invention is characterized in that when position specifications are received for a plurality of times, the speed determination section regards two points corresponding to position specifications received last as a first point and a second point, respectively, and determines a speed of the sequential display, based on a time interval between the first point and the second point.

According to the invention, when position specifications are received for a plurality of times, the speed determination section regards two points corresponding to the position specifications received last as the first point and the second point, respectively, and determines a speed of the sequential display of the group of images, based on a time interval from reception of the position specification of the first point to reception of the position specification of the second point.

The display device according to the present invention is characterized in that each image in the group of images is provided with a page number, and the display determination section includes a display order determination section for determining whether display order is page order or reverse page order, based on which of X-coordinate values, or which of Y-coordinate values, representing the two points is greater.

According to the invention, the display determination section includes the display order determination section, and the display order determination section compares the X-coordinate values, or the Y-coordinate values, representing the two points with each other to determine which is greater, and determines, based on the determination result, whether the display order is page order or reverse page order for the sequential display of the group of images.

The display device according to the present invention is characterized in that when position specifications are received for a plurality of times after a first point corresponding to a previous position specification, the display order determination section regards a point corresponding to a position specification received last as a second point, and determines the display order, based on which of X-coordinate values, or which of Y-coordinate values, representing the first point and the second point is greater.

According to the invention, when position specifications are received for a plurality of times after the first point, the display order determination section regards a point corresponding to the position specification received last as the second point, compares the X-coordinate values, or Y-coordinate values, representing the first point and the second point with each other to determine which is greater, and determines, based on the determination result, whether the display order is page order or reverse page order for the sequential display of the group of images.

The display method according to the present invention is a display method, in a display device including a display section for displaying a group of images consisting of a plurality of images on a page basis, and a position receiving section for receiving a position specification on a display screen of the display section, for sequentially displaying the group of images based on position specifications received by the position receiving section, the method comprising: a step of receiving position specifications of two points at an edge region of an image by the position receiving section; and a step of determining a speed of the sequential display, based on a distance between the two points.

The recording medium according to the present invention is a non-transitory computer-readable recording medium storing a computer program for causing a computer constituting a display device including a display section for displaying a group of images consisting of a plurality of images on a page basis, and a position receiving section for receiving a position specification on a display screen of the display section, to sequentially display the group of images based on position specifications received by the position receiving section, said computer program comprising: a step of causing the computer to receive position specifications of two points at an edge region of an image by the position receiving section; and a step of causing the computer to determine a speed of the sequential display, based on a distance between the two points.

According to the invention, when the position receiving section received position specifications of two points at the edge region of the image, the distance between the two points is evaluated, and a speed of the sequential display of the group of images is determined based on the distance.

The display method to the present invention is characterized in that each image in the group of images is provided with a page number, and the method further comprises a step of determining whether display order is page order or reverse page order, based on which of X-coordinate values, or which of Y-coordinate values, representing the two points is greater.

The recording medium according to the present invention is characterized in that each image in the group of images is provided with a page number, and the computer program further comprises a step of causing the computer to determine whether display order is page order or reverse page order, based on which of X-coordinate values, or which of Y-coordinate values, representing the two points is greater.

According to the invention, the X-coordinate values, or the Y-coordinate values, representing the two points are compared with each other to determine which is greater, and whether the display order is page order or reverse page order is determined based on the determination result for the sequential display of the group of images.

According to the invention, the above-mentioned computer program is stored in the recording medium. A computer retrieves the computer program from the recording medium, and the above-mentioned display device and display method are implemented by the computer.

According to the present invention, since the speed and display order of the sequential display are determined based on a mutual relationship between two points corresponding to position specifications received at the edge region of the image, the page turning speed and the page turning direction (display order) of so-called page-turning display (sequential display) are adjusted by a simple operation without requiring a special structure, thereby giving users improved handling performance.

The above and further objects and features will more fully be apparent from the following detailed description with accompanying drawings.

### BRIEF DESCRIPTION OF THE SEVERAL VIEWS OF THE DRAWINGS

FIG. 1 A functional block diagram illustrating an essential configuration of a book data display device of Embodiment 1 of the present invention.

FIG. 2 An explanatory view for explaining a way of turning pages of a real book.

FIG. 3 An explanatory view for explaining a way of turning pages of a real book.

FIG. 4 A schematic view illustrating a state in which a user holds with one hand the book data display device of Embodiment 1 of the present invention.

FIG. 5 An explanatory view for explaining how the speed of page-turning display is determined in the book data display device of Embodiment 1 of the present invention.

FIG. 6 An explanatory view for explaining how the speed of page-turning display is determined in the book data display device of Embodiment 1 of the present invention.

FIG. 7 An explanatory view for explaining how the speed of page-turning display is determined in the book data display device of Embodiment 1 of the present invention.

FIG. 8 An explanatory view for explaining how a direction of page-turning display is determined in the book data display device of Embodiment 1 of the present invention.

FIG. 9 An explanatory view for explaining how a direction of page-turning display is determined in the book data display device of Embodiment 1 of the present invention.

FIG. 10 A flowchart illustrating the process of determining the speed of page-turning display in the book data display device of Embodiment 1 of the present invention.

FIG. 11A flowchart illustrating the process of determining the direction of page-turning display in the book data display device of Embodiment 1 of the present invention.

FIG. 12 A flowchart illustrating the process of determining the speed of page-turning display in the book data display device of Embodiment 1 of the present invention.

FIG. 13 A functional block diagram illustrating an essential configuration of a book data display device of Embodiment 2 of the present invention.

### DETAILED DESCRIPTION

Referring to the drawings, the following will explain in detail the present invention in view of an example in which a display device, a display method and a recording medium according to an embodiment of the present invention are applied to a book data display device having a so-called electronic book function.

### Embodiment 1

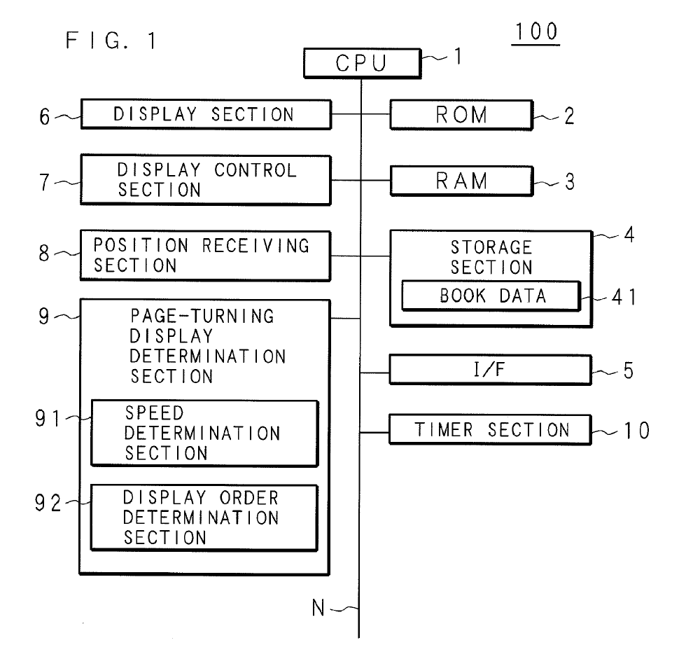

FIG. 1 is a functional block diagram illustrating an essential configuration of a book data display device 100 of Embodiment 1 of the present invention. The book data display device 100 comprises a CPU 1, a ROM 2, and a RAM 3.

The ROM 2 stores in advance various kinds of control programs, and basically fixed data among parameters for operations, etc. The RAM 3 temporarily stores data and allows retrieval of data irrespective of the stored order, stored location etc. For example, the RAM 3 stores a program retrieved from the ROM 2, various kinds of data generated by the execution of the program, and parameters which vary suitably when executing the program.

The CPU 1 controls the following various hardware devices through a bus N by loading a control program stored in advance in the ROM 2 onto the RAM 3 and executing the program, and operates the whole devices as the book data display device 100 of the present invention. Moreover, the CPU 1 accepts an input of a processing instruction from a user through a later-described position receiving section 8.

The book data display device 100 of Embodiment 1 of the present invention further comprises a storage section 4, an I/F (Interface) 5, a display section 6, a display control section 7, the position receiving section 8, a page-turning display determination section 9 (display determination section), and a timer section 10.

The storage section 4 is composed of a non-volatile storage medium, such as, for example, a flash memory, an EEPROM, an HDD, an MRAM (magnetoresistive random access memory), an FeRAM (ferroelectric random access memory), or an OUM. The storage section 4 stores book data 41. The book data is content data of an electronic book consisting of a plurality of images. The display control section 7 displays, based on the book data, the content (group of images) of the electronic book in the display section 6.

Book data is stored in the storage section 4 by downloading the book data from an external communication network through the I/F 5, or reading the book data recorded in a removable recording medium, not shown.

The display section 6 is composed, for example, of an LCD or EL (Electroluminescence) panel, and displays the content of an electronic book. The display screen of the display section 6 is covered with the position receiving section 8.

The display control section 7 is composed of a processor, such as a DSP (Digital Signal Processor), and controls the display of an image in the display section 6. For example, the display control section 7 generates image data about an image to be displayed in the display section 6, according to an instruction from the CPU 1. More specifically, the display control section 7 generates image data about the content of an electronic book to be displayed in the display section 6, based on the book data, and displays an image based on the generated image data (the content of the electronic book) in the display section 6.

Moreover, the display control section 7 performs animation display in which screen pages (content) of the displayed electronic book are turned in page order, or reverse page order, on the screen of the display section 6, based on a determination result (the speed and direction of page-turning display) by the page-turning display determination section 9, thereby implementing page-turning display which realizes, in a pseudo manner, turning pages of a real book.

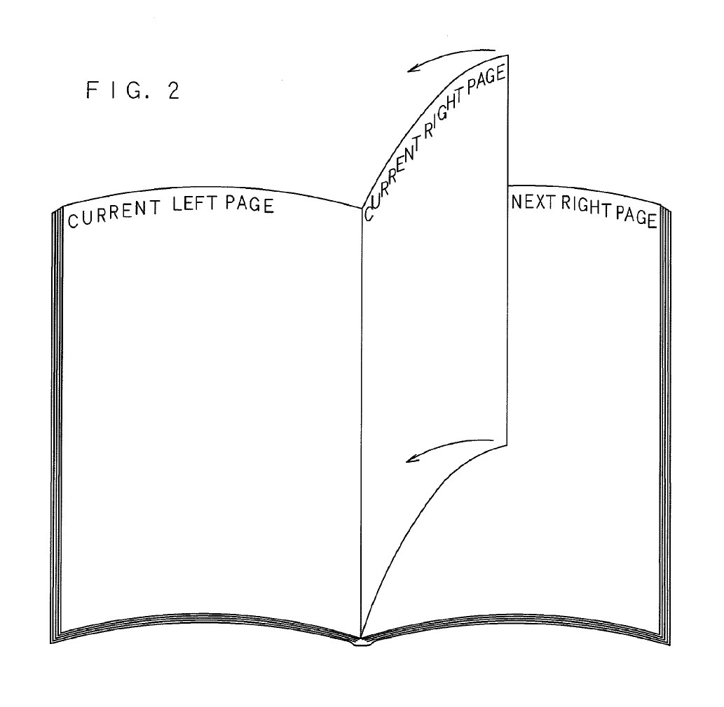

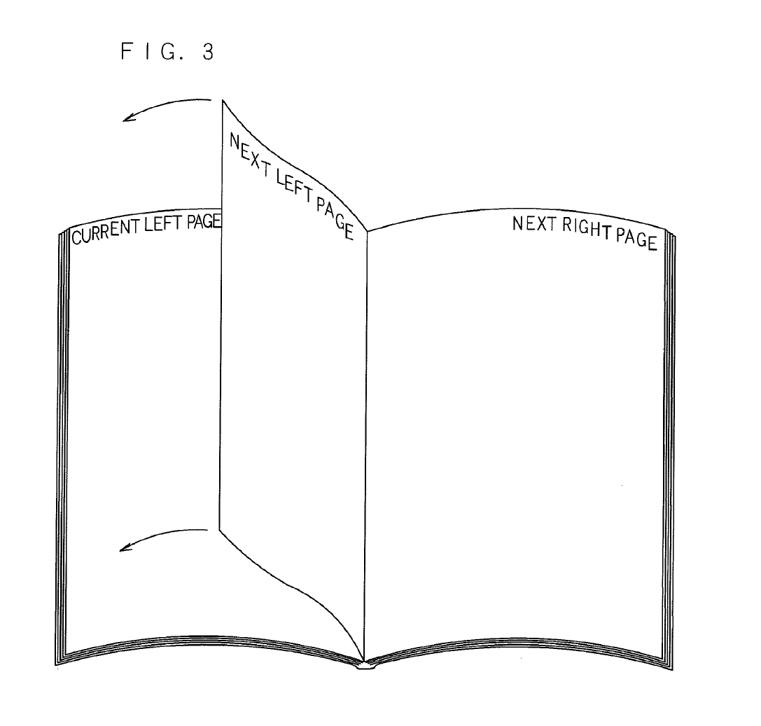

FIG. 2 and FIG. 3 are explanatory views for explaining a way of turning pages of a real book. For example, when actually turning one page on the right side of a fully opened book to show the next left page and right page, the current right page is turned and the edge region of the current right page (the next left page) approaches and moves to the edge region of the current left page, and consequently the visible area of the current left page and right page is reduced, while the visible area of the next left page and right page is increased.

The page-turning display is a known art for producing a visual effect of turning pages of a book one page at a time. For example, when a user manipulates the screen of the display section 6 as if turning a page of a real book with a fingertip, the edge region of the current right page or the next left page (image) approaches and moves to the edge region of the current left page (image), and thus the process of changing the visible areas of the respective pages and switching of displayed images in the visible areas are performed.

The position receiving section 8 is a so-called touch panel and arranged to cover the display screen of the display section 6. The position receiving section 8 receives a position specification on the display screen of the display section 6 by a touch operation of the user. The position receiving section 8 detects a change in the pressure caused by the touch operation of the user's fingertip, or detects an electric signal caused by static electricity, and detects coordinates on the display screen of the display section 6 corresponding to the contact point of the user's fingertip and generates a signal specifying the coordinates. The position receiving section 8 is not limited to this, and may be configured with a pointing device (for example a stylus pen).

For example, when the user touched the position receiving section 8 with his/her fingertip and then drugged the fingertip for a given distance and removed the fingertip, the position receiving section 8 receives position specifications of one point (a first point) corresponding to the touched position and other point (a second point) corresponding to the removed position. Hence, signals specifying the coordinates of the two points corresponding to the position specifications received from the user are sent to the CPU 1 and the page-turning display determination section 9 by the position receiving section 8.

The CPU 1 recognizes, based on the signals specifying the coordinates obtained from the positioning receiving section 8, the receipt of a given specification (for example, page-turning display) from the user through the position receiving section 8.

The page-turning display determination section 9 determines, based on the mutual relationship between the two points corresponding to the position specifications received by the position receiving section 8, the speed of page-turning display (speed of sequential display) and the direction of page-turning display (display order in the sequential display) in the page-turning display performed by the display control section 7. In other words, the page-turning display determination section 9 determines, based on the positional relationship between the two points, or the time relationship between the position specifications, the page-turning speed and direction for the page-turning display. The page-turning display determination section 9 determines the page-turning speed and direction for page-turning display in which pages are turned sequentially as if turning pages of a real book, instead of turning pages one page at a time as described above.

More specifically, the page-turning display determination section 9 comprises a speed determination section 91. The speed determination section 91 determines, based on the signals specifying the coordinates obtained from the position receiving section 8, the speed of page-turning display, or, in other words, a page-turning speed, in performing the page-turning display of the electronic book in page order, or reverse page order.

Moreover, the page-turning display determination section 9 comprises a display order determination section 92. The display order determination section 92 determines, based on the signals specifying the coordinates obtained from the position receiving section 8, whether the page-turning display of the electronic book is performed in page order or reverse page order.

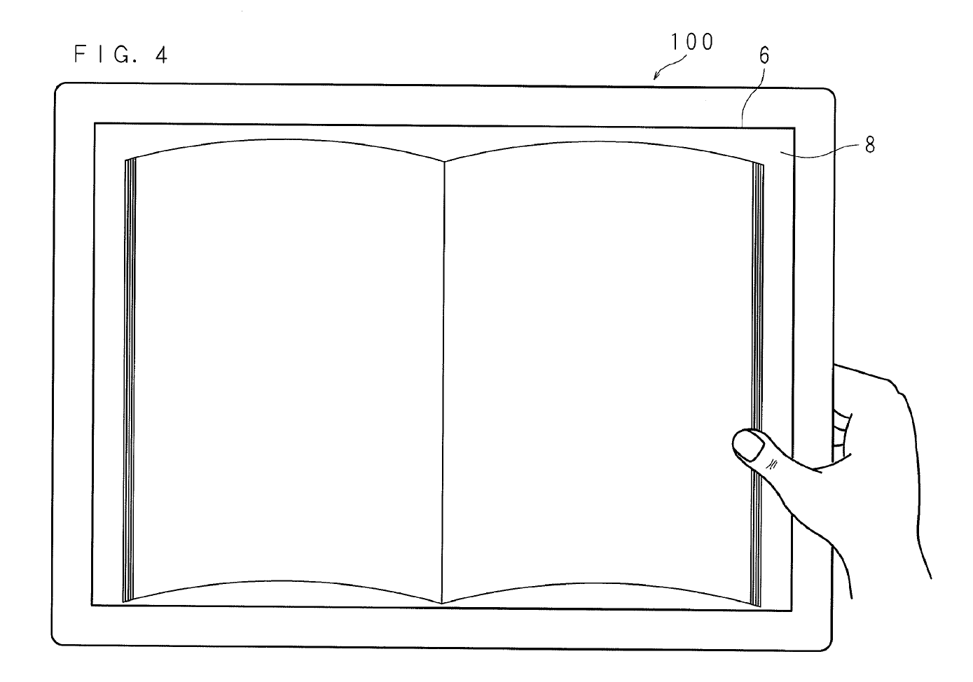

The following will explain in detail how the book data display device 100 of Embodiment 1 of the present invention determines the speed and direction of page-turning display. FIG. 4 is a schematic view illustrating a state in which the user holds with one hand the book data display device 100 of Embodiment 1 of the present invention. When performing the page-turning display, as illustrated in FIG. 4, the user touches a part of the display section 6 (position receiving section 8) with his/her thumb fingertip. More specifically, the user touches with his/her thumb an edge region in a lateral direction (when viewed in the drawing) of an image page of an electronic book displayed in the display section 6.

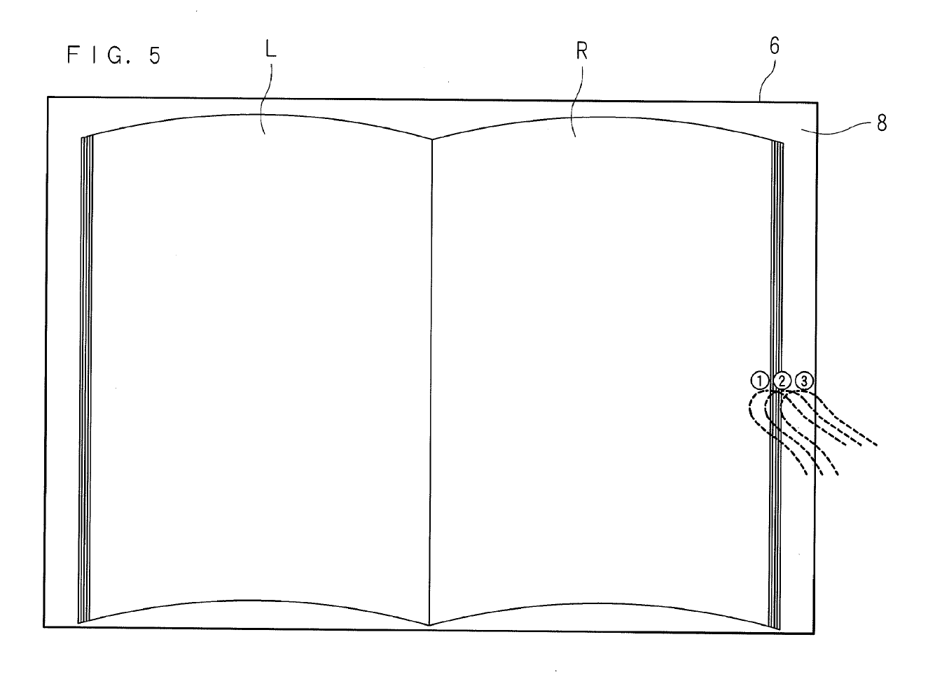

FIG. 5 to FIG. 7 are explanatory views for explaining how the speed of page-turning display is determined in the book data display device 100 of Embodiment 1 of the present invention. These drawings illustrate the book in a fully opened state, and indicate the thumb by the dotted line. For the sake of explanation, the following will be explained by way of an example in which the page-turning display is performed in page order.

For example, the user touches with his/her thumb the “1” point (first point) at the edge region of right-side image page R of the electronic book and slides the thumb outwards to the “2” point (second point) in touch with the page, and then stops the operation without removing the thumb from the page. In this case, the position receiving section 8 finds coordinates corresponding to the “1” point and the “2” point and sends signals representing the coordinates to the speed determination section 91.

The speed determination section 91 receives the signals representing the coordinates of the “1” point and the “2” point from the position receiving section 8, and evaluates the distance between the “1” point and the “2” point, based on these coordinates.

Meanwhile, the distance between the two points corresponding to the position specifications received by the position receiving section 8 and a speed of page-turning display are stored in association with each other in a part of the storage section 4. For example, if the speed of turning one page at a time as in the above-mentioned page-turning display is one-time speed, then two times speed, four times speed or etc. according to the distance is associated for the page-turning display in which pages are sequentially turned.

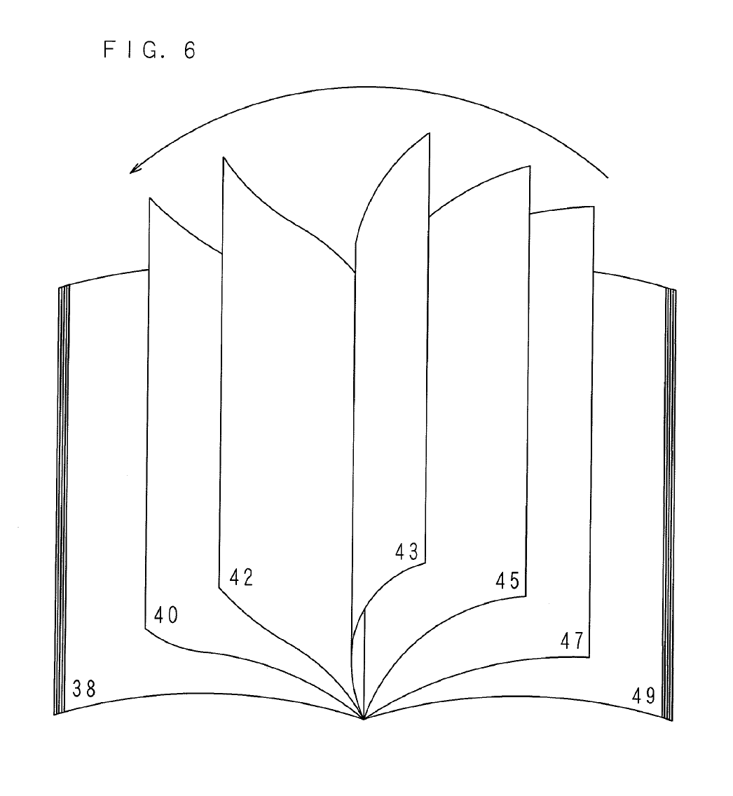

The speed determination section 91 which evaluated the distance between the “1” point and the “2” point retrieves a speed of page-turning display corresponding to the evaluated distance from the storage section 4 and determines it as the speed of page-turning display. For example, when the speed of page-turning display determined by the speed determination section 91 is two times speed, then page-turning display is performed (see FIG. 6) to turn pages sequentially at a speed two times faster than the speed of page-turning display when turning one page at a time (see FIG. 2 or FIG. 3).

Meanwhile, it is supposed that the user may desire page-turning display faster than the speed of page-turning display being performed currently. In this case, the user just slides the thumb outwards and stops at the “3” point. At this time, the thumb is still touching the screen. In other words, the user moves the thumb to widen the distance from the “1” point.

When the user performed such an operation, the position receiving section 8 finds coordinates corresponding to the “3” point (second point) and sends a signal representing the coordinates to the speed determination section 91. Then, the speed determination section 91 receives the signal representing the coordinates of the “3” point from the position receiving section 8 and evaluates the distance between the “1” point and the “3” point.

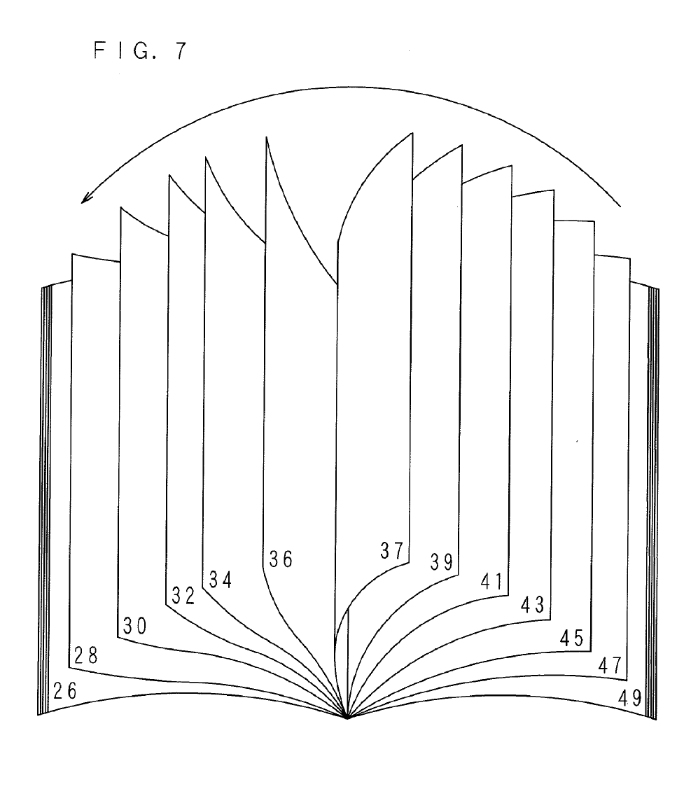

The speed determination section 91 retrieves a speed of page-turning display corresponding to the evaluated distance between the “1” point and the “3” point from the storage section 4 and determines it as the speed of page-turning display. For example, if the speed of page-turning display determined by the speed determination section 91 is four times speed, then a page-turning display is performed to turn pages sequentially (see FIG. 7) at a speed faster than the page-turning display performed at two times speed (see FIG. 6).

For example, for the page-turning display to be performed at four times speed, processes of increasing the number of image pages being turned in animation display (for example, page 40 to page 47 in FIG. 6) by two times compared to the page-turning display performed at two times speed and reducing the image switching interval between the respective image pages by one half are performed to realize pseudo page turning as if sequentially turning pages of a real book.

Meanwhile, it is supposed that the user may desire page-turning display slower than the speed of page-turning display being performed currently. In this case, the user just slides the thumb inwards to return to, for example, the “2” point from the “3” point and stops it. In other words, the user moves the thumb to reduce the distance from the “1” point.

When the user performed such an operation, the position receiving section 8 finds again coordinates corresponding to the “2” point (second point) and sends a signal representing the coordinates to the speed determination section 91. The speed determination section 91 evaluates the distance between the “1” point and the “2” point, retrieves a speed of page-turning display corresponding to the distance from the storage section 4 and determines it as the speed of page-turning display.

In short, the speed determination section 91 determines the speed of page-turning display, based on the distance between a point (first point) corresponding to a previous position specification and a point (second point) corresponding to a position specification received last among points corresponding to position specifications received later. Meanwhile, when the user removes his/her thumb from the display section 6 (position receiving section 8), the page-turning display is finished.

As described above, the book data display device 100 of Embodiment 1 of the present invention is capable of sequentially increasing/decreasing the page turning speed by a simple operation of sliding the thumb after the user touches the edge region of the electronic book (image page) with the thumb.

Thus, the book data display device 100 of Embodiment 1 of the present invention enables the user to find desired information randomly while sequentially turning pages in a manner similar to a real book and feel more resemblance to a real book.

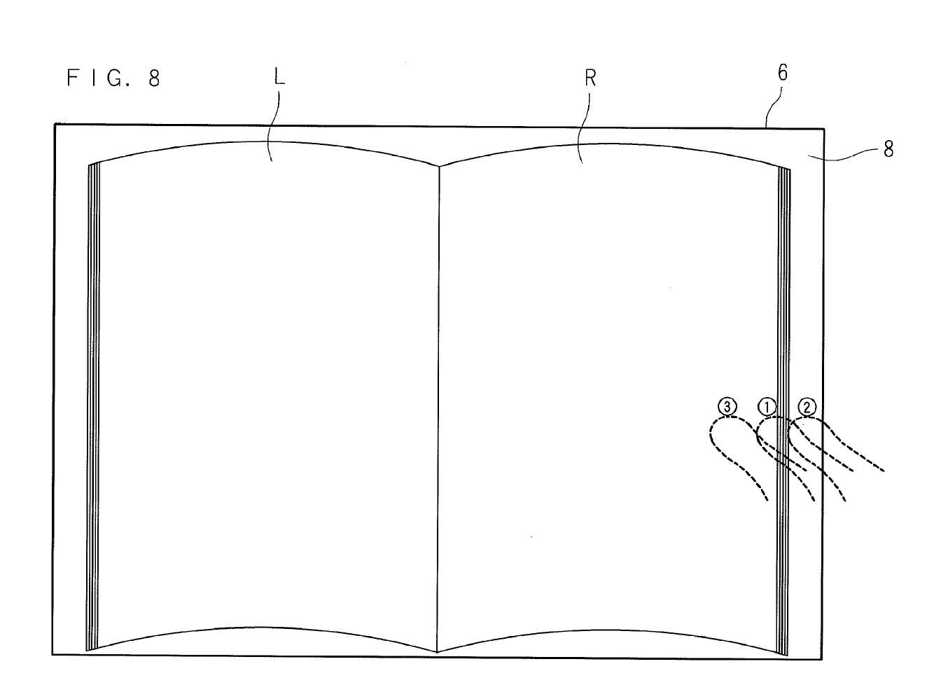

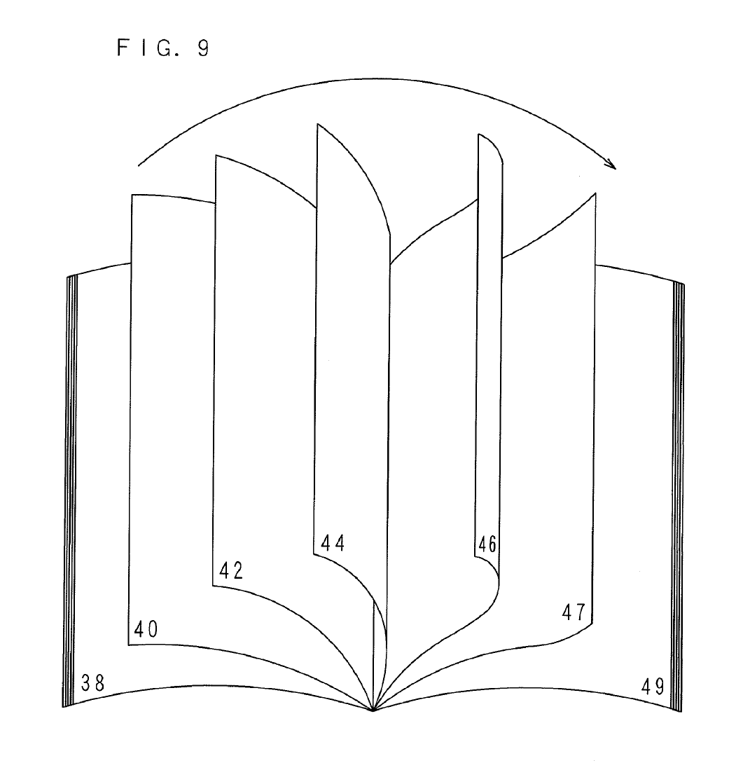

FIG. 8 or FIG. 9 is an explanatory view for explaining how the direction of page-turning display is determined in the book data display device 100 of Embodiment 1 of the present invention. These drawings illustrate an electronic book in a fully opened state, and indicate the thumb by the dotted line. Note that, for the sake of explanation, the speed of page-turning display is not taken into consideration.

For example, the user touches with his/her thumb the “1” point (first point) at the edge region of right-side image page R of the electronic book and slides the thumb outwards to the “2” point (second point) in touch with the page, and then stops the operation without removing the thumb. In this case, the position receiving section 8 finds coordinates corresponding to the “1” point and the “2” point and send signals representing the coordinates to the display order determination section 92.

The display order determination section 92 receives the signals representing the coordinates of the “1” point and the “2” point from the position receiving section 8, and determines, based on these coordinates, whether the X-coordinate value (or the Y-coordinate value) of the “1” point is greater or smaller than the X-coordinate value (or the Y-coordinate value) of the “2” point. For example, if the X-coordinate value corresponding to a position specification received later is greater than the X-coordinate value of a point corresponding to the previously received position specification, the display order determination section 92 determines a display in page order as the direction of page-turning display. On the other hand, if the X-coordinate value of the point corresponding to the position specification received later is smaller than the X-coordinate value of the point corresponding to the previously received position specification, the display order determination section 92 determines a display in reverse page order as the direction of page-turning display.

In this example, since the point corresponding to the previously received position specification is the “1” point and the point corresponding to the position specification received later is the “2” point, the X-coordinate value of the “2” point is greater than the X-coordinate value of the “1” point. Therefore, the display order determination section 92 determines a display in page order as the direction of page-turning display. In this case, as illustrated in FIG. 6, pseudo page turning is realized as if sequentially turning pages of a real book in page order.

On the other hand, when the user touches with his/her thumb the “1” point (first point) at the edge region of right-side image page R of the electronic book and slides the thumb inwards to the “3” point (second point) in touch with the page, the X-coordinate value of the point (the “3” point) corresponding to the position specification received later is smaller than the X-coordinate value of the point corresponding to the previously received position specification, and therefore the display order determination section 92 determines a display in reverse page order as the direction of page-turning display. In this case, as illustrated in FIG. 9, pseudo page turning is realized as if sequentially turning pages of a real book in reverse page order.

Meanwhile, it is supposed a case in which the user touches with his/her thumb the “1” point (first point) at the edge region of right-side image page R of the electronic book and slides the thumb outwards to the “2” point (second point) once in touch with the page, and then further slides the thumb inwards and outwards and stops at the “3” point after elapsing a given time.

In this case, the position receiving section 8 finds coordinates corresponding to the “3” point and sends a signal representing the coordinates to the display order determination section 92. The display order determination section 92 receives the signal, determines, based on the coordinates, whether the X-coordinate value of the “1” point is greater or smaller than the X-coordinate value of the “3” point, and determines the direction of page-turning display.

In this case, since the X-coordinate value of the point (the “3” point) corresponding to the position specification received later is smaller than the X-coordinate value of the point (the “1” point) corresponding to the previously received position specification, the display order determination section 92 determines a display in reverse page order as the direction of page-turning display.

Thus, as illustrated in FIG. 6, the slide operation to the “3” point is performed during the page-turning display in which pages of the electronic book are sequentially turned in page order, and then, as illustrated in FIG. 9, the processing is switched to a page-turning display in which pages are turned sequentially in reverse page order.

In short, the display order determination section 92 determines the direction of page-turning display, based on whether the X-coordinate value (or the Y-coordinate value) of the point (first point) corresponding to the previously received position specification is greater or smaller than the X-coordinate value (or the Y-coordinate value) of the point (second point) corresponding to the position specification received last among the points corresponding to the position specifications received later.

The above explanation explains an example in which the edge region of right-side image page R is touched, but the present invention is not limited to this, and the same can be said for a case in which the edge region of left-side image page L is touched.

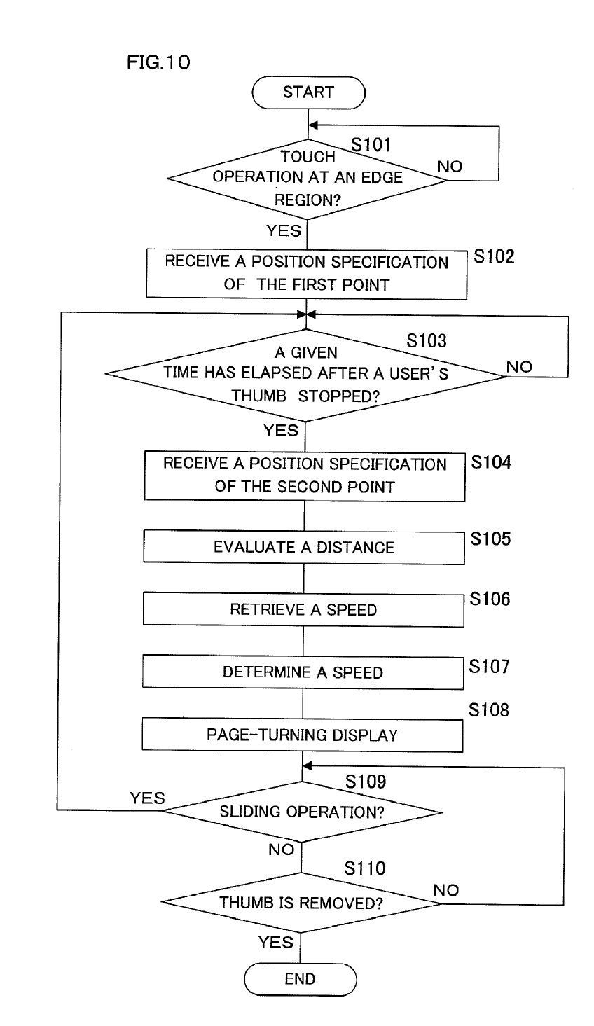

FIG. 10 is a flowchart illustrating the process of determining the speed of page-turning display in the book data display device 100 of Embodiment 1 of the present invention. With reference to FIG. 5, the process will be explained below by defining a point corresponding to a previously received position specification as the first point and a point corresponding to a position specification received later as the second point for the sake of explanation. Note that, in the following explanation, the direction of page-turning display is not taken into consideration.

When the user touched a given point on the position receiving section 8 (display section 6), the position receiving section 8 receives a position specification of the given point. The position receiving section 8 sends to the CPU 1 a signal representing coordinates of the given point corresponding to the position specification received from the user. The CPU 1 determines, based on the signal obtained from the position receiving section 8, whether the above-mentioned operation of touching the given point is a touch operation at an edge region of an image page displayed in the display section 6 (S101).

If the CPU 1 determines that the operation is not a touch operation at the edge region of the image page displayed in the display section 6 (S101: NO), it waits until the user performs a touch operation at the edge region of the image.

On the other hand, if the CPU 1 determines that the operation is a touch operation at the edge region of the image page displayed in the display section 6 (S101: YES), the position receiving section 8 receives a position specification of the above-mentioned given point (for example, the “1” point in FIG. 5) corresponding to the touch operation as the first point (S102).

After touching at the “1” point in FIG. 5, for example, when the user performed a sliding operation to the “2” point in FIG. 5 and stopped the thumb at the “2” point in FIG. 5, the CPU 1 instructs the timer section 10 to measure time.

The CPU 1 determines, based on the result of measuring time by the timer section 10, whether or not a given time has elapsed after the user's thumb stopped at the “2” point in FIG. 5 (S103).

If the CPU 1 determines that the given time has not elapsed after the user's thumb stopped at the “2” point in FIG. 5 (S103: NO), it waits until the given time elapses.

On the other hand, if the CPU 1 determines that the given time has elapsed after the user's thumb stopped at the “2” point in FIG. 5 (S103: YES), the position receiving section 8 receives a position specification of the “2” point in FIG. 5 as the second point (S104).

Thus, the signals representing the first point and the second point corresponding to the position specifications received from the user are sent to the page-turning display determination section 9 (speed determination section 91) by the position receiving section 8.

The speed determination section 91 receives the signals representing coordinates of the first point and the second point from the position receiving section 8, and evaluates the distance between the first point and the second point based on these coordinates (S105).

The speed determination section 91 which evaluated the distance between the first point and the second point retrieves a speed of page-turning display corresponding to the evaluated distance from the storage section 4 (S106), and determines the retrieved speed as the speed of page-turning display by the display control section 7 (S107). Since this process is described above, a detailed explanation will be omitted.

Next, the display control section 7 performs page-turning display based on the speed of page-turning display determined by the speed determination section 91 (S108) and implements pseudo page turning as if sequentially turning pages of a real book.

Thereafter, the CPU 1 determines, based on the signals obtained from the position receiving section 8, whether or not the sliding operation of the user's thumb was performed again (S109).

For example, if the user slid the thumb further to the “3” point from the “2” point in FIG. 5 and the CPU 1 determines that the sliding operation of the user's thumb was performed again (S109: YES), the process is returned to S103. Thereafter, a new position specification of the second point is received by the sliding operation. In other words, a position specification of the “3” point in FIG. 5 as the new second point is received.

On the other hand, if the CPU 1 determines that the sliding operation of the user's thumb was not performed (S109: NO), it determines, based on the signals received from the position specification section 8, whether or not the user removed the thumb from the display section 6 (position receiving section 8) (S110).

If the CPU 1 determines that the user removed the thumb from the display section 6 (position receiving section 8) (S110: YES), it finishes the process.

On the other hand, if the CPU 1 determines that the user did not remove the thumb from the display section 6 (position receiving section 8) (S110: NO), it returns the process to S109.

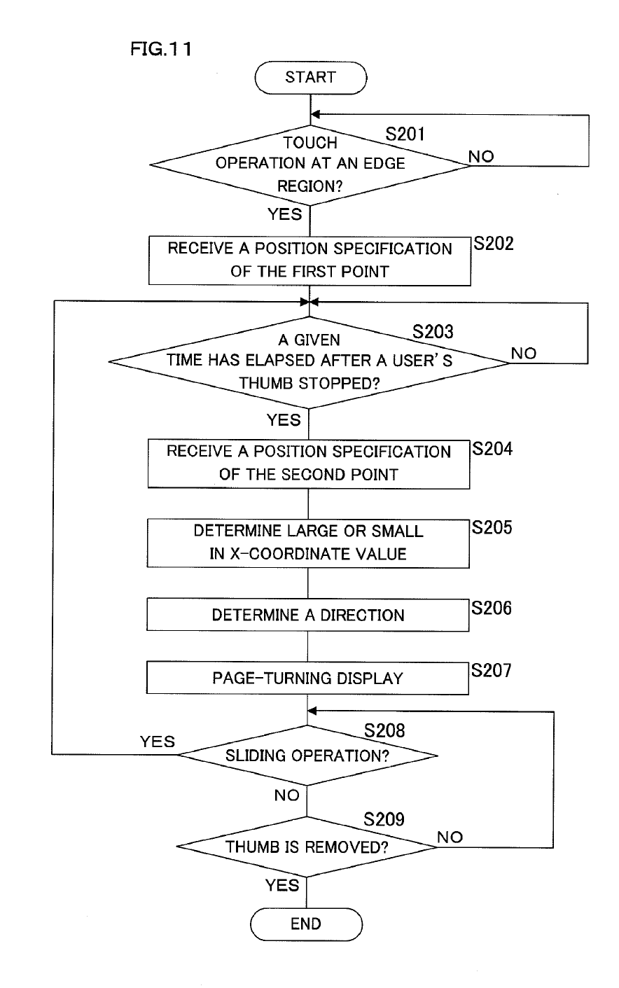

FIG. 11 is a flowchart illustrating the process of determining the direction of page-turning display in the book data display device 100 of Embodiment 1 of the present invention. With reference to FIG. 8, the process will be explained below by defining a point corresponding to a previously received position specification as the first point and a point corresponding to a position specification received later as the second point for the sake of explanation. Note that, in the following explanation, the speed of page-turning display is not taken into consideration.

When the user touched a given point on the position receiving section 8 (display section 6), the position receiving section 8 receives a position specification of the given point. At this time, the CPU 1 determines, based on a signal obtained from the position receiving section 8, whether or not the above operation of touching the given point is a touch operation at an edge region of an image page displayed in the display section 6 (S201).

If the CPU 1 determines that the operation is not a touch operation at the edge region of the image page displayed in the display section 6 (S201: NO), it waits until the user performs a touch operation at the edge region of the image page. On the other hand, if the CPU 1 determines that the operation is a touch operation at the edge region of the image page displayed in the display section 6 (S201: YES), the position receiving section 8 receives a position specification of the above-mentioned given point (for example, the “1” point in FIG. 8) corresponding to the touch operation as the first point (S202).

After touching the “1” point in FIG. 8, for example, when the user performed a sliding operation to the “2” point in FIG. 8 and stopped the thumb at the “2” point in FIG. 8, the CPU 1 instructs the timer section 10 to measure time.

The CPU 1 determines, based on the result of measuring time by the timer section 10, whether or not a given time has elapsed after the user's thumb stopped at the “2” point in FIG. 8 (S203).

If the CPU 1 determines that the given time has not elapsed after the user's thumb stopped at the “2” point in FIG. 8 (S203: NO), it waits until the given time elapses. On the other hand, if the CPU 1 determines that the given time has elapsed after the user's thumb stopped at the “2” point in FIG. 8 (S203: YES), the position receiving section 8 receives a position specification of the “2” point in FIG. 8 as the second point (S204).

Thus, the signals representing the first point and the second point corresponding to the position specifications received from the user are sent to the page-turning display determination section 9 (display order determination section 92) by the position receiving section 8.

The display order determination section 92 receives the signals representing coordinates of the first point and the second point from the position receiving section 8, and, for example, determines whether the X-coordinate value of the first point is greater or smaller than the X-coordinate value of the second point (S205).

Based on the result of determination about which of the X-coordinate values is greater, the display order determination section 92 determines a direction of page-turning display by the display control section 7 (S206). For example, if the X-coordinate value of the second point is greater than the X-coordinate value of the first point, the display order determination section 92 determines the display in page order as the direction of page-turning display. On the other hand, if the X-coordinate value of the second point is smaller than the X-coordinate value of the first point, the display order determination section 92 determines the display in reverse page order as the direction of page-turning display.

Next, the display control section 7 performs page-turning display based on the direction of page-turning display determined by the display order determination section 92 (S207) and implements pseudo page turning as if sequentially turning pages of a real book.

Thereafter, the CPU 1 determines, based on the signals obtained from the position receiving section 8, whether or not the sliding operation of the user's thumb was performed again (S208).

For example, if the user slid the thumb further to the “3” point from the “2” point in FIG. 8 and the CPU 1 determines that the sliding operation of the user's thumb was performed again (S208: YES), the process is returned to S203. Thereafter, a new position specification of the second point is received by the sliding operation. In other words, a position specification of the “3” point in FIG. 8 as a new second point is received.

On the other hand, if the CPU 1 determines that the sliding operation of the user's thumb was not performed (S208: NO), it determines, based on the signals received from the position specification section 8, whether or not the user removed the thumb from the display section 6 (position receiving section 8) (S209).

If the CPU 1 determines that the user removed the thumb from the display section 6 (position receiving section 8) (S209: YES), it finishes the process. On the other hand, if the CPU 1 determines that the user did not remove the thumb from the display section 6 (position receiving section 8) (S209: NO), it returns the process to S208.

The above description explains an example in which the speed of page-turning display is determined based on the distance between two points, namely, a point corresponding to a previously received position specification and a point corresponding to a position specification received later, but the present invention is not limited to this. For example, the speed of page-turning display can be determined based on the time interval between the two points. In other words, the speed of page-turning display is determined based on the time interval from the previously received position specification to reception of a later position specification.

The following will explain the process of determining the speed of page-turning display, based on the time interval in receiving position specifications of two points, namely, a point corresponding to a previously received position specification and a point corresponding to a position specification received later. With reference to FIG. 5, the process will be explained below by assuming, for the sake of explanation, that the user's thumb slid from the “1” point to the “2” point over 0.5 seconds and stopped, and then, after a given time, slid again from the “2” point to the “3” point over 1 second. During the sliding operation, position specifications of two points, namely, the slide start point and the slide end point, are received, and the speed of page-turning display is determined based on the time interval between the two points.

For example, the user touches with his/her thumb the “1” point (first point) at the edge region of right-side image page R of the electronic book and slides the thumb outwards to the “2” point (second point) in touch with the page, and then stops the operation without removing the thumb. When the slide is started, the position receiving section 8 receives a position specification of the “1” point as the slide start point. When the position receiving section 8 received the position specification, the CPU 1 instructs the timer section 10 to start measuring time. Moreover, when the slide is finished, the position receiving section 8 receives a position specification of the “2” point as the slide end point. When the position receiving section 8 received the position specification, the CPU 1 instructs the timer section 10 to finish measuring time. The result of measuring time by the timer section 10 is sent to the speed determination section 91. The result of measuring time by the timer section 10, that is, the time interval between the “1” point and the “2” point, is 0.5 seconds as mentioned above.

The speed determination section 91 receives from the timer section 10 the result of measuring time, that is, the time interval between the “1” point and the “2” point in receiving the position specifications, and determines, based on this result, a speed of page-turning display.

More specifically, in a part of an area in the storage section 4, the time interval between the two points corresponding to the position specifications received by the position receiving section 8, that is, the result of measuring time by the timer section 10, and the speed of page-turning display are stored in association with each other. For example, the result of measuring time and the speed of page-turning display are in proportion to each other and the shorter the result of measuring time, the faster the speed of page-turning display. When the speed determination section 91 obtained the result of measuring time from the timer section 10, it retrieves the speed of page-turning display corresponding to the result of measuring time from the storage section 4 and determines it as the speed of page-turning display.

Meanwhile, it is supposed that the user may desire page-turning display slower than the speed of page-turning display being performed currently. In this case, the user slowly slides the thumb from the “2” point and stops, for example, at the “3” point. At this time, the thumb is still touching the screen. In this case, the slide time, that is, the time interval between the “2” point and the “3” point, is 1 second as mentioned above.

In this case, the position receiving section 8 receives a position specification of the “2” point when the sliding is started, and the CPU 1 instructs the timer section 10 to start measuring time. In addition, the position receiving section 8 receives a position specification of the “3” point when the sliding is finished, and the CPU 1 instructs the timer section 10 to finish measuring time. The result of measuring time by the timer section 10 is sent to the speed determination section 91.

When the speed determination section 91 obtained the result of measuring time from the timer section 10, it retrieves a speed of page-turning display corresponding to the result of measuring time from the storage section 4, and determines it as the speed of page-turning display. In this example, since the result of measuring time by the timer section 10 is 1 second, a slower speed of page-turning display is determined compared to the above-mentioned case where the speed is 0.5 seconds.

On the other hand, for example, there may be a case where the user slid his/her thumb from the “3” point to the “2” point again. In this case, for example, if the slide time, that is, the time interval between the “3” point and the “2” point, is 0.5 seconds, the speed determination section 91 retrieves again a speed of page-turning display corresponding to 0.5 seconds as the result of measuring time from the storage section 4, and determines it as the speed of page-turning display.

In other words, in the case where the speed determination section 91 determines the speed of page-turning display based on the time interval between two points corresponding to position specifications, if there are a plurality of points corresponding to received position specifications, the speed determination section 91 determines the speed of page-turning display, based on the time interval between two points corresponding to the position specification received last.

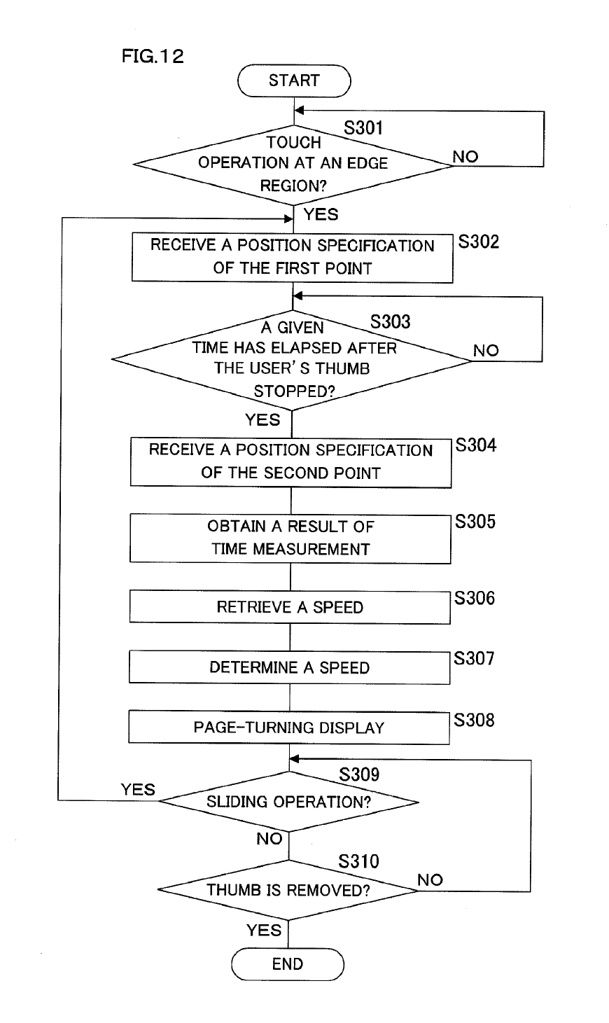

FIG. 12 is a flowchart illustrating the process of determining the speed of page-turning display in the book data display device 100 of Embodiment 1 of the present invention. With reference to FIG. 5, the process will be explained below by defining a point corresponding to a previously received position specification as the first point and a point corresponding to a position specification received later as the second point for the sake of explanation. Note that, in the following explanation, the direction of page-turning display is not taken into consideration.

When the user touched a given point on the position receiving section 8 (display section 6), the position receiving section 8 receives a position specification of the given point. At this time, the CPU 1 determines, based on the signal obtained from the position receiving section 8, whether or not the above operation of touching the given point is a touch operation at an edge region of an image page displayed in the display section 6 (S301).

If the CPU 1 determines that the operation is not a touch operation at the edge region of the image page displayed in the display section 6 (S301: NO), it waits until the user performs a touch operation at the edge region of the image page. On the other hand, if the CPU 1 determines that the operation is a touch operation at the edge region of the image page displayed in the display section 6 (S301: YES), the position receiving section 8 receives a position specification of the above-mentioned given point (for example, the “1” point in FIG. 5) corresponding to the touch operation as the first point (S302). At this time, the CPU 1 instructs the timer section 10 to start a first time measurement.

After touching the “1” point in FIG. 5, for example, when the user performed a sliding operation to the “2” point in FIG. 5 and stopped the thumb at the “2” point in FIG. 5, the CPU 1 instructs the timer section 10 to finish the first time measurement and gives a new instruction to start a second time measurement.

The CPU 1 determines, based on the result of the second time measurement by the timer section 30, whether or not a given time has elapsed after the user's thumb stopped at the “2” point in FIG. 5 (S303).

If the CPU 1 determines that the given time has not elapsed after the user's thumb stopped at the “2” point in FIG. 5 (S303: NO), it waits until the given time elapses. On the other hand, if the CPU 1 determines that the given time has elapsed after the user's thumb stopped at the “2” point in FIG. 5 (S303: YES), the position receiving section 8 receives a position specification of the “2” point in FIG. 5 as the second point (S304).

At this time, the result of the first time measurement by the timer section 10 is sent to the speed determination section 91. The speed determination section 91 obtains from the timer section 10 the result of the first time measurement, that is, the time interval between the “1” point and the “2” point in FIG. 5 (S305).

When the speed determination section 91 obtained the result of the first time measurement from the timer section 10, it retrieves a speed of page-turning display corresponding to the result of measuring time from the storage section 4 (S306), and determines the retrieved speed as the speed of page-turning display by the display control section 7 (S307). Since this process is described above, a detailed explanation will be omitted.

Next, the display control section 7 performs page-turning display based on the speed of page-turning display determined by the speed determination section 91 (S308).

Thereafter, the CPU 1 determines, based on the signals obtained from the position receiving section 8, whether or not the sliding operation of the user's thumb was performed again (S309). For example, if the user slid the thumb further to the “3” point from the “2” point in FIG. 5 and the CPU 1 determines that the sliding operation of the user's thumb was performed again (S309: YES), the process is returned to S302. Thereafter, position specifications for the first point and the second point are newly received by the sliding operation. In other words, a position specification of the “2” point in FIG. 5 as a new first point and a position specification of the “3” point in FIG. 5 as a new second point are received.

On the other hand, if the CPU 1 determines that the sliding operation of the user's thumb was not performed (S309: NO), it determines, based on the signals received from the position specification section 8, whether or not the user removed the thumb from the display section 6 (position receiving section 8) (S310).

If the CPU 1 determines that the user removed the thumb from the display section 6 (position receiving section 8) (S310: YES), it finishes the process. On the other hand, if the CPU 1 determines that the user did not remove the thumb from the display section 6 (position receiving section 8) (S310: NO), it returns the process to S309.

The above explains the case in which the speed of page-turning display is determined based on the time interval between two points, that is, the time interval from a previously received position specification to reception of a later position specification, but the present invention is not limited to this. For example, it may be possible to find a slide speed between the two points, based on the coordinates of the two points and the time interval, and determine a speed of page-turning display based on the found slide speed.

### Embodiment 2

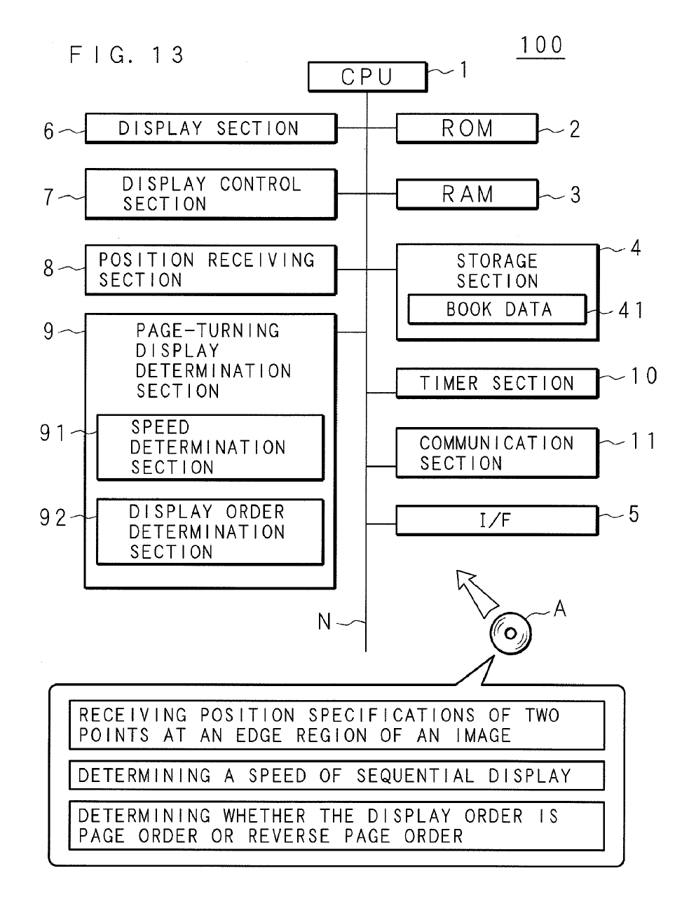

FIG. 13 is a functional block diagram illustrating an essential configuration of a book data display device 100 of Embodiment 2 of the present invention. The book data display device 100 of Embodiment 2 is configured to allow a computer program for performing operations to be provided in the form of a removable recording medium A, such as a CD-ROM, through an I/F 5. Further, the book data display device 100 of Embodiment 2 is configured to be capable of downloading the computer program from an external device (not shown) through a communication section 11. The following will explain the content.

The book data display device 100 of Embodiment 2 comprises an external (or internal) recording medium reading device (not shown), inserts into the recording medium reading device the removable recording medium A storing a program for receiving position specifications of two points at an edge region of an image through a position receiving section, determining a speed of sequential display of a group of images, based on a first point corresponding to the previous position specification and a second point corresponding to the position specification received later, determining whether the display order is page order or reverse page order, based on which of the X-coordinate values, or which of the Y-coordinate values, of the first point and the second point is greater, and, for example, causes a CPU 1 to install the program in a ROM 2. The program is loaded into a RAM 3 and executed. Hence, it functions as the book data display device 100 of Embodiment 1 of the present invention.

The recording medium may be a so-called program medium, or a medium carrying program codes in a fixed manner, such as tapes including a magnetic tape and a cassette tape, disks such as magnetic disks including a flexible disk and a hard disk, and optical disks including a CD-ROM, an MO, an MD, and a DVD, cards such as an IC card (including a memory card) and an optical card, or a semiconductor memory like a mask ROM, an EPROM, an EEPROM, and a flash ROM.

The recording medium may be a medium carrying program codes in a flowing manner like by downloading the program codes from a network through the communication section 11. In the case where the program is downloaded from a communication network in such a manner, a program for downloading may be stored in advance in the main device, or installed from another recording medium. The present invention can also be implemented in the form of a computer data signal embedded in a carrier wave in which the program codes are embodied by an electronic transfer.

The same parts as in Embodiment 1 are designated with the same reference numbers, and detailed explanations thereof are omitted.

As this description may be embodied in several forms without departing from the spirit of essential characteristics thereof, the present embodiments are therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A display device, including a display section for displaying a group of images consisting of a plurality of images on a page basis, and a position receiving section for receiving a position specification on a display screen of the display section, for a sequential display of the group of images, based on position specifications received by the position receiving section, wherein
the position receiving section receives position specifications of two points at an edge region of an image, and
the display device comprises a display determination section for determining, based on a mutual relationship between the two points, a speed and display order of the sequential display.

2. The display device according to claim 1, wherein
the display determination section includes a speed determination section for determining a speed of the sequential display, based on a distance between the two points.

3. The display device according to claim 2, wherein
when position specifications are received for a plurality of times after a first point corresponding to a previous position specification, the speed determination section regards a point corresponding to a position specification received last as a second point, and determines a speed of the sequential display based on a distance between the first point and the second point.

4. The display device according to claim 1, wherein
the display determination section includes a speed determination section for determining, based on a time interval between the two points, a speed of the sequential display.

5. The display device according to claim 4, wherein
when position specifications are received for a plurality of times, the speed determination section regards two points corresponding to position specifications received last as a first point and a second point, respectively, and determines a speed of the sequential display, based on a time interval between the first point and the second point.

6. The display device according to claim 2, wherein
each image in the group of images is provided with a page number, and
the display determination section includes a display order determination section for determining whether display order is page order or reverse page order, based on which of X-coordinate values, or which of Y-coordinate values, representing the two points is greater.

7. The display device according to claim 6, wherein
when position specifications are received for a plurality of times after a first point corresponding to a previous position specification, the display order determination section regards a point corresponding to a position specification received last as a second point, and determines the display order, based on which of X-coordinate values, or which of Y-coordinate values, representing the first point and the second point is greater.

8. A display device, including a display section for displaying a group of images consisting of a plurality of images on a page basis, and position receiving means for receiving a position specification on a display screen of the display section, for a sequential display of the group of images based on position specifications received by the position receiving means, wherein
the position receiving means receives position specifications of two points at an edge region of an image, and
the display device comprises determination means for determining, based on a mutual relationship between the two points, a speed and display order of the sequential display.

9. The display device according to claim 8, wherein
the determination means includes speed determination means for determining a speed of the sequential display, based on a distance between the two points.

10. The display device according to claim 9, wherein
when position specifications are received for a plurality of times after a first point corresponding to a previous position specification, the speed determination means regards a point corresponding to a position specification received last as a second point, and determines a speed of the sequential display, based on a distance between the first point and the second point.

11. The display device according to claim 8, wherein
the determination means includes speed determination means for determining a speed of the sequential display, based on a time interval between the two points.

12. The display device according to claim 11, wherein
when position specifications are received for a plurality of times, the speed determination means regards two points corresponding to position specifications received last as a first point and a second point, respectively, and determines a speed of the sequential display, based on a time interval between the first point and the second point.

13. The display device according to claim 9, wherein
each image in the group of images is provided with a page number, and
the determination means includes display order determination means for determining whether display order is page order or reverse page order, based on which of X-coordinate values, or which of Y-coordinate values, representing the two points is greater.

14. The display device according to claim 13, wherein
when position specifications are received for a plurality of times after a first point corresponding to a previous position specification, the display order determination means regards a point corresponding to a position specification received last as a second point, and determines the display order, based on which of X-coordinate values, or which of Y-coordinate values, representing the first point and the second point is greater.

15. A display method, in a display device including a display section for displaying a group of images consisting of a plurality of images on a page basis, and a position receiving section for receiving a position specification on a display screen of the display section, for sequentially displaying the group of images based on position specifications received by the position receiving section, the method comprising:
a step of receiving position specifications of two points at an edge region of an image by the position receiving section; and
a step of determining a speed of the sequential display, based on a distance between the two points.

16. The display method according to claim 15, wherein
each image in the group of images is provided with a page number, and
the method further comprises a step of determining whether display order is page order or reverse page order, based on which of X-coordinate values, or which of Y-coordinate values, representing the two points is greater.

17. A non-transitory computer-readable recording medium storing a computer program for causing a computer constituting a display device including a display section for displaying a group of images consisting of a plurality of images on a page basis, and a position receiving section for receiving a position specification on a display screen of the display section, to sequentially display the group of images based on position specifications received by the position receiving section, said computer program comprising:
a step of causing the computer to receive position specifications of two points at an edge region of an image by the position receiving section; and
a step of causing the computer to determine a speed of the sequential display, based on a distance between the two points.

18. The recording medium according to claim 17, wherein
each image in the group of images is provided with a page number, and
said computer program further comprises a step of causing the computer to determine whether display order is page order or reverse page order, based on which of X-coordinate values, or which of Y-coordinate values, representing the two points is greater.
